(19) United States
(12) Patent Application Publication
(10) Pub. No.: US 2021/0356805 A1
(43) Pub. Date: Nov. 18, 2021

(54) DISPLAY DEVICE AND MANUFACTURING METHOD THEREOF

(71) Applicant: TCL CHINA STAR OPTOELECTRONICS TECHNOLOGY CO., LTD., Shenzhen (CN)

(72) Inventor: Xingwu CHEN, Shenzhen (CN)

(73) Assignee: TCL CHINA STAR OPTOELECTRONICS TECHNOLOGY CO., LTD., Shenzhen (CN)

(21) Appl. No.: 16/627,353

(22) PCT Filed: Dec. 19, 2019
(86) PCT No.: PCT/CN2019/126619

§ 371 Date: Dec. 30, 2019

(30) Foreign Application Priority Data
Dec. 10, 2019 (CN) 201911254813.2

(51) Int. Cl. G02F 1/1335; G02F 1/1333

(52) U.S. Cl. CPC G02F 1/133512; G02F 1/133514; G02F 1/133305

(57) ABSTRACT

A display device and a manufacturing method thereof are provided. The display device includes a first substrate, a second substrate, and liquid crystal disposed between the first substrate and the second substrate. The liquid crystal includes a chiral agent, the first substrate is provided with a driving electrode, and the second substrate is provided with a black matrix. The driving electrode is arranged asymmetrically, or the black matrix is arranged asymmetrically. This can effectively improve issues of partial dark lines, improve transmittance of the display device, and realize high-transmittance display.

### FIELD OF INVENTION

The present disclosure relates to the field of display technologies, and more particularly to a display device and a manufacturing method thereof.

### BACKGROUND OF INVENTION

At present, commonly used liquid crystal displays include twist nematic (TN) mode, vertical alignment (VA) mode, in-plane switching (IPS) mode, and fringe field switching (FFS) mode. The most commonly used VA display mode is polymer stabilized vertical alignment (PSVA) technology, because of its advantages of high contrast and fast response speed. PSVA liquid crystal displays have become the most extensive display technology at present, but people's requirements for display technology are getting higher and higher. Wide viewing angles and high transmittance have always been important directions for future development. However, viewing angles of the PSVA display mode are relatively poor. That is, differences in brightness and color between a side viewing angle and a front viewing angle are obvious. A relationship between transmission (Tr) and Δn (optical birefringence value) of PSVA is shown in formula 1. As a wavelength increases, Δn gradually decreases. This results in an inversion tends to occur in a short-wavelength region Tr. That is, when a voltage is increased, a long-wavelength region Tr increases and the short-wavelength region Tr decreases, resulting in a yellowish color (low blue brightness, high red and green brightnesses, and yellowish color point).

$$Tr ∝ \frac{1}{2} {sin}^{2} \frac{πΔ nd}{λ} \qquad ( 1 )$$

### Technical Problem

One of the most effective ways to increase transmittance in the prior art is to increase Δnd in the above formula. Increasing d will increase a thickness of a panel cell, which will increase amount of liquid crystal used and the cost. The usual way is to keep d unchanged and increase Δn. However, increasing Δn makes it easier to reverse the short-wavelength Tr and cause yellowing. And the yellower the color point, the worse the viewing angles (an optical adjustment is needed to maintain a white point balance, resulting in a greater difference in brightness between front and side views). By adding a chiral agent to the liquid crystal, the liquid crystal can be poured in multiple directions. At the same time, Δn is increased to change the liquid crystal display mode to the inverted TN mode. This can effectively improve the transmittance, increase the transmittance of blue pixels, and improve iuuses of yellowish white points. In addition, liquid crystal molecules can be tilted in different directions, so that different azimuth angles have the same brightness, thereby achieving high transmittance and large viewing angle display. However, during design, the liquid crystal is rotated due to the presence of the chiral agent. This causes the liquid crystal molecules in a partial area to fail to pour along a direction of maximum transmittance, thereby producing dark lines, which affects the transmittance of the display device.

### SUMMARY OF INVENTION

The present invention provides a display device and a manufacturing method thereof, and solves issues of poor transmittance of a display device and partial dark lines in the prior art.

In one aspect, an embodiment of the present invention provides a display device comprising a first substrate, a second substrate, and liquid crystal disposed between the first substrate and the second substrate. The liquid crystal comprises a chiral agent, the first substrate is provided with a driving electrode, and the second substrate is provided with a black matrix. The driving electrode is arranged asymmetrically, or the black matrix is arranged asymmetrically.

In the display device according to an embodiment of the present invention, a pitch is 2 to 7 times a liquid crystal cell gap.

In the display device according to an embodiment of the present invention, a product of an optical birefringence value of the liquid crystal and a thickness of a panel cell ranges from 300 nm to 500 nm.

In the display device according to an embodiment of the present invention, the driving electrode is arranged asymmetrically according to dark lines around pixels.

In the display device according to an embodiment of the present invention, a width of the black matrix is increased in a wide area of dark lines, and the width of the black matrix is reduced in a narrow area of the dark lines.

In the display device according to an embodiment of the present invention, the first substrate is a thin film transistor array substrate, the second substrate is a color filter substrate, and the liquid crystal is a negative liquid crystal.

In the display device according to an embodiment of the present invention, the first substrate and the second substrate are each a flexible substrate or a common substrate.

In another aspect, an embodiment of the present invention provides a manufacturing method of a display device comprising doping a chiral agent in liquid crystal and disposing the liquid crystal doped with the chiral agent between a first substrate and a second substrate; and asymmetrically arranging a driving electrode or asymmetrically arranging a black matrix.

In the manufacturing method according to an embodiment of the present invention, the method of doping the chiral agent in liquid crystal and disposing the liquid crystal doped with the chiral agent between the first substrate and the second substrate comprises: injecting the liquid crystal into a liquid crystal layer, wherein a product of an optical birefringence value of the liquid crystal and a thickness of a panel cell ranges from 300 nm to 500 nm; adding the chiral agent to the liquid crystal, wherein a pitch is 2 to 7 times a liquid crystal cell gap; and bonding to form a liquid crystal cell and performing a predetermined process on the liquid crystal.

In the manufacturing method according to an embodiment of the present invention, the method of asymmetrically arranging the driving electrode or asymmetrically arranging the black matrix comprises: asymmetrically arranging the driving electrode according to dark lines around pixels; and increasing a width of the black matrix in a wide area of the dark lines and reducing the width of the black matrix in a narrow area of the dark lines.

### Beneficial Effect

Embodiments of the invention have the following beneficial effects:

Effectively improve issues of partial dark lines, improve transmittance of the display device, and realize high-transmittance display.

### DESCRIPTION OF DRAWINGS

The present invention will be further described below with reference to the accompanying drawings and embodiments. In the drawings:

FIG. 1 is a schematic structural diagram of a pitch.

FIG. 2 is a schematic structural diagram of a liquid crystal cell gap.

FIG. 3 is a schematic diagram of an asymmetric arrangement of a black matrix according to an embodiment of the present invention.

FIG. 4 is a schematic diagram of an asymmetrical arrangement of a driving electrode according to an embodiment of the present invention.

FIG. 5 is a schematic diagram of an asymmetrical arrangement of a driving electrode and a symmetrical arrangement of a black matrix according to an embodiment of the present invention.

FIG. 6 is a flowchart of a manufacturing method of a display device according to an embodiment of the present invention.

### DETAILED DESCRIPTION OF PREFERRED EMBODIMENTS

In order to have a clearer understanding of the technical features, objects, and effects of the present invention, specific embodiments of the present invention will now be described in detail with reference to the drawings.

An embodiment of the present invention provides a display device including a first substrate, a second substrate, and liquid crystal disposed between the first substrate and the second substrate. The liquid crystal includes a chiral agent, a driving electrode is disposed on the first substrate, and a black matrix is disposed on the second substrate. Preferably, the first substrate is a thin film transistor array substrate, the second substrate is a color filter substrate, and the liquid crystal is a negative liquid crystal. In the display device according to an embodiment of the present invention, the first substrate and the second substrate may be flexible substrates or common substrates. Add liquid crystal between the two substrates, Δnd ranges between 300 nm and 500 nm, where Δn is an optical birefringence value, and d is a thickness of a panel cell. In addition, the chiral agent is added to the liquid crystal, and a pitch is maintained to be 2 to 7 times a liquid crystal cell gap, thereby increasing transmittance while improving yellowing or greening of color points, reducing color shift, and improving viewing angles.

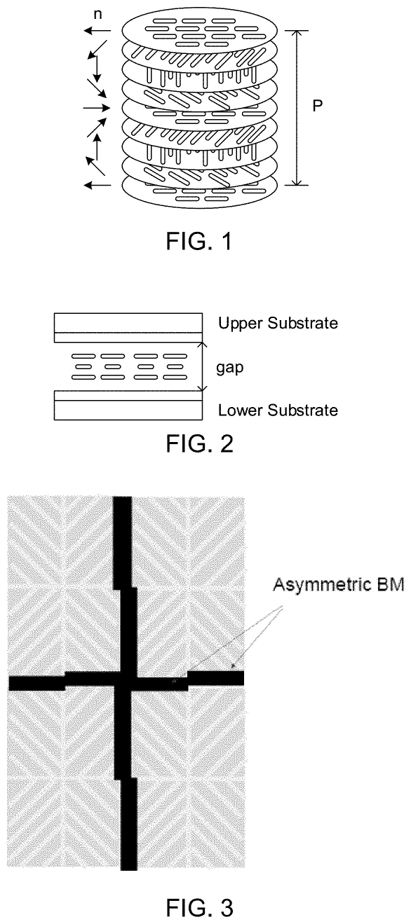

Referring to FIG. 1 and FIG. 2, FIG. 1 is a schematic structural diagram of a pitch, and FIG. 2 is a schematic structural diagram of a liquid crystal cell gap. In FIG. 1, chiral liquid crystals are arranged in layered liquid crystals, the liquid crystals in the layer are ordered, and the liquid crystals are rotated at a certain angle between the layers. In FIG. 1, a left side n indicates a direction of rotation. After directors of different layers rotate 360° in a spiral direction, a layer distance that returns to an original direction is a pitch, so P is the pitch in the figure. In FIG. 2, the liquid crystal cell gap is a gap, and the gap is a distance between an upper substrate and a lower substrate. Therefore, the pitch is 2 to 7 times the liquid crystal cell gap, which is 2≤P/gap≤7.

The driving electrode is arranged asymmetrically, or the black matrix is arranged asymmetrically. Referring to FIG. 3, FIG. 3 is a schematic diagram of an asymmetric arrangement of a black matrix according to an embodiment of the present invention. The asymmetric arrangement of the black matrix is specifically: increasing a width of the black matrix in a wide area of the dark lines and reducing the width of the black matrix in a narrow area of the dark lines.

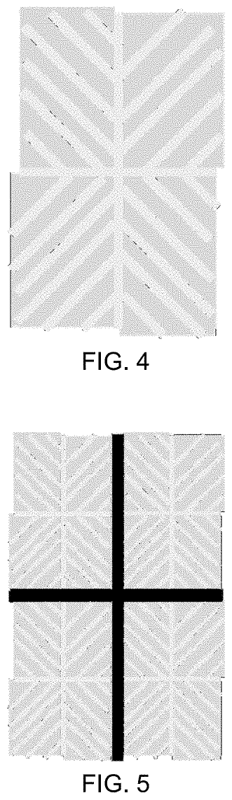

Referring to FIG. 4, FIG. 4 is a schematic diagram of an asymmetrical arrangement of a driving electrode according to an embodiment of the present invention. The asymmetrical arrangement of the driving electrode is: the asymmetrical arrangement of the driving electrode according to the dark lines around pixels.

Referring to FIG. 5, FIG. 5 is a schematic diagram of an asymmetrical arrangement of a driving electrode and a symmetrical arrangement of a black matrix according to an embodiment of the present invention. This embodiment is a further refinement of the embodiment shown in FIG. 4.

In addition, an asymmetric ITO design can also be used. In obvious areas of the dark lines, an ITO is designed to extend to increase electric field intensity at edges, and this induces alignment of surrounding liquid crystals, and shifts the dark lines outward to improve transmittance. ITO conductive glass is manufactured by plating a layer of indium tin oxide (commonly known as ITO) film based on soda-lime-based or silicon-boron-based substrate glass by sputtering, evaporation and other methods. A special ITO conductive glass for a liquid crystal display is also coated with a silicon dioxide barrier layer before plating an ITO layer to prevent sodium ions on a substrate glass from diffusing into liquid crystal in a cell.

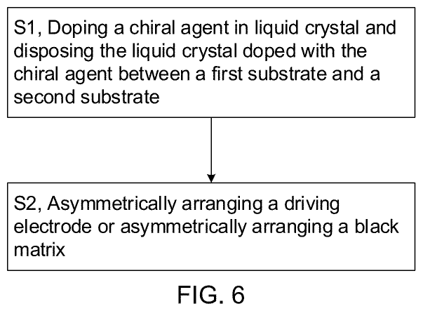

Referring to FIG. 6, FIG. 6 is a flowchart of a manufacturing method of a display device according to an embodiment of the present invention. The manufacturing method of the display device includes steps S1-S2.

S1, a chiral agent is doped in liquid crystal, and the liquid crystal doped with the chiral agent is disposed between a first substrate and a second substrate. The second substrate may optionally add red, green, and blue color filter layers, a black matrix, and the like to achieve beneficial effects such as color display and light leakage prevention. Step S1 includes steps S11 to S13.

S11, the liquid crystal is injected into a liquid crystal layer, wherein a product of an optical birefringence value of the liquid crystal and a thickness of a panel cell ranges from 300 nm to 500 nm. For example, an alignment layer is made on a substrate, and then liquid crystal is injected into the liquid crystal layer. The liquid crystal is a negative liquid crystal, and liquid crystal Δnd ranges between 300 nm and 500 nm. Generally, when manufacturing a display, upper and lower electrode surfaces are also coated with a thin layer of polymer plastic (such as: polyimide), which is called a liquid crystal molecule alignment layer.

S12, the chiral agent is added to the liquid crystal, and the pitch is 2 to 7 times the liquid crystal cell gap. Due to the addition of the chiral agent to the liquid crystal, the liquid crystal in a region with a weaker electric field around pixels is found to rotate, resulting in different rotation angles in different regions, causing differences in widths of the dark lines. In addition, in the liquid crystal with the chiral agent, experiments in the prior art have confirmed that adding a chiral agent under different voltage states can effectively increase a short wavelength region, that is, a region with a wavelength below 500 nm can increase transmittance, thereby increasing brightness of blue light, that is, to improve issues of greenish and yellowish white spots.

S13, laminating is performed to form a liquid crystal cell, and a predetermined process is performed on the liquid crystal. The liquid crystal cell is bonded to form the liquid crystal and a polymer stabilized vertical alignment (PSVA) process is performed, that is, power is applied for UV irradiation (ultraviolet irradiation) to form a pretilt angle to form a liquid crystal display device as shown.

S2, the driving electrode is arranged asymmetrically, or the black matrix is arranged asymmetrically. Step S2 includes steps S21-S22.

S21, the driving electrode is arranged asymmetrically according to the dark lines around the pixels. Referring to FIG. 2, the driving electrode is adjusted according to dark line regions, and areas of the dark line regions finally formed are irregular and asymmetric.

S22, a width of the black matrix is increased in a wide area of the dark lines, and the width of the black matrix is reduced in a narrow area of the dark lines. This solution uses an asymmetric design of the black matrix, widens the black matrix in the wide area of the dark lines, and narrows the width of the black matrix in the narrow area. The asymmetric design of the black matrix can be effectively used to reduce a pixel pitch and achieve the effect of increasing transmittance.

Through the above scheme, the chiral agent is added to the liquid crystal, and Δn (that is, an optical birefringence value) is increased, so that the liquid crystal display mode becomes a reverse twist nematic (TN) mode. This can effectively increase transmittance, increase transmittance of blue pixels, and improve issues of yellowish white points. Adopt asymmetric electrode or black matrix design to improve peripheral dark lines and increase transmittance.

The embodiments of the present invention have been described above with reference to the accompanying drawings, but the present invention is not limited to the above specific implementations. The specific embodiments described above are merely illustrative and not restrictive. Those of ordinary skill in the art can make many forms under the inspiration of the present invention without departing from the scope of the present invention and the scope of the claims. These are all within the protection of the present invention.

What is claimed is:

1. A display device, comprising:
a first substrate, a second substrate, and liquid crystal disposed between the first substrate and the second substrate;
wherein the liquid crystal comprises a chiral agent, the first substrate is provided with a driving electrode, and the second substrate is provided with a black matrix;
wherein the driving electrode is arranged asymmetrically, or the black matrix is arranged asymmetrically, a product of an optical birefringence value of the liquid crystal and a thickness of a panel cell ranges from 300 nm to 500 nm, and the first substrate and the second substrate are each a flexible substrate or a common substrate.

2. A display device, comprising:
a first substrate, a second substrate, and liquid crystal disposed between the first substrate and the second substrate;
wherein the liquid crystal comprises a chiral agent, the first substrate is provided with a driving electrode, and the second substrate is provided with a black matrix;
wherein the driving electrode is arranged asymmetrically, or the black matrix is arranged asymmetrically.

3. The display device according to claim 2, wherein a pitch is 2 to 7 times a liquid crystal cell gap.

4. The display device according to claim 2, wherein a product of an optical birefringence value of the liquid crystal and a thickness of a panel cell ranges from 300 nm to 500 nm.

5. The display device according to claim 2, wherein the driving electrode is arranged asymmetrically according to dark lines around pixels.

6. The display device according to claim 2, wherein a width of the black matrix is increased in a wide area of dark lines, and the width of the black matrix is reduced in a narrow area of the dark lines.

7. The display device according to claim 2, wherein the first substrate is a thin film transistor array substrate, the second substrate is a color filter substrate, and the liquid crystal is a negative liquid crystal.

8. The display device according to claim 2, wherein the first substrate and the second substrate are each a flexible substrate or a common substrate.

9. A manufacturing method of a display device, comprising:
doping a chiral agent in liquid crystal and disposing the liquid crystal doped with the chiral agent between a first substrate and a second substrate; and
asymmetrically arranging a driving electrode or asymmetrically arranging a black matrix.

10. The manufacturing method according to claim 9, wherein the method of doping the chiral agent in liquid crystal and disposing the liquid crystal doped with the chiral agent between the first substrate and the second substrate comprises:
injecting the liquid crystal into a liquid crystal layer, wherein a product of an optical birefringence value of the liquid crystal and a thickness of a panel cell ranges from 300 nm to 500 nm;
adding the chiral agent to the liquid crystal, wherein a pitch is 2 to 7 times a liquid crystal cell gap; and
bonding to form a liquid crystal cell and performing a predetermined process on the liquid crystal.

11. The manufacturing method according to claim 9, wherein the method of asymmetrically arranging the driving electrode or asymmetrically arranging the black matrix comprises:
asymmetrically arranging the driving electrode according to dark lines around pixels; and
increasing a width of the black matrix in a wide area of the dark lines and reducing the width of the black matrix in a narrow area of the dark lines.
